(19) United States
(12) Patent Application Publication
(10) Pub. No.: US 2006/0099233 A1
(43) Pub. Date: May 11, 2006

(54) Granular formulation of neem seed extract and its process thereof

(75) Inventors: Damarla Sreenivasa Rao, Bangalore (IN); Davendra Kumar, Bangalore (IN); Liza Joz, Bangalore (IN); Mambully Chandrasekaran Gopinathan, Bangalore (IN)

Correspondence Address: KILYK & BOWERSOX, P.L.L.C., 400 HOLIDAY COURT, SUITE 102, WARRENTON, VA, 20186, US

(73) Assignee: E.I.D. Parry (India) Limited

(21) Appl. No.: 11/298,273

(22) Filed: Dec. 9, 2005

Related U.S. Application Data
(63) Continuation-in-part of application No. PCT/IN05/00001, filed on Jan. 3, 2005.

(30) Foreign Application Priority Data
Mar. 31, 2004 (IN) 293/CHE/2003

(51) Int. Cl. A01N 65/00; A01N 25/00

(52) U.S. Cl. 424/405; 424/761

(57) ABSTRACT

The present invention relates to an improved granular formulation of neem seed extract containing azadirachtin having enhanced storage stability, and the ability for gradual release of azadirachtin for application to plant rhizosphere. The formulation contains inert particulate as a carrier, at least one lipophilic substance as a deactivator/binder, optional colorant and neem seed extract containing azadirachtin. The formulation provides the gradual release of azadirachtin and effectively at the point of application. The invention also relates to a process for the preparation of the formulation by coating the carrier with a lipophilic substance, subsequently impregnating the coated carrier with neem seed extract followed by optional coating with a colorant and finally lipophilic a substance, such as by spraying and drying at a temperature below 50° C.

### FIELD OF THE INVENTION

The present invention relates to an improved granular formulation having enhanced storage stability, gradual release of azadirachtins for application to plant rhizosphere, the formulation comprising neem seed extract, an inert carrier particulate, a lipophilic substance, and optionally a colorant. The invention also relates to a process for the preparation of the granular formulation.

### BACKGROUND OF THE INVENTION

Protecting plants from pest is a complex task. Usually different pest effects the growth of various parts of the plant through out its life cycle. It is a general practice to apply plant protection chemicals or pesticides to protect plants from various pests for obtaining higher crop yields in agriculture, horticulture, floriculture and silviculture. These chemicals are also used to protect plants in gardens, lawns and household plants. Most of the damage due to the pest and diseases occur on visible aerial parts of the plant and hence it is a practice to spray plant protection chemicals on aerial parts to control pest. The conventional plant protection agents mostly act as contact poisons to pests resulting in mortality or their suppression and thus providing protection to the plant. The effectiveness of the plant protection agents which act on the basis of their contact toxicity depends on the type of formulation, efficiency of the spray mechanisms which provide effective coverage and penetrability of the active compound on the aerial parts of the plant. Generally it is reported that aerial sprays waste about 20-30% of the product due to drifting during the spray, which results in loss of valuable active ingredients apart from the inherent spread of the toxic compounds into air, water and soil causing contamination to the environment. These problems can be avoided using systemic plant protection molecules which can be absorbed by the plant when delivered to the plant rhizosphere through various delivery systems, such as granules, pellets, and the like.

Most of the plant protection chemicals are toxic to non target organisms and humans apart from their longer persistence in the environment. Due to increasing awareness of the environmental and toxicity concerns of these chemicals, there has been a demand for alternative molecules which are active against target pest but safer to human and non-target organisms, and which are biodegradable, causing no harm to the environment.

Extracts of various parts of the neem tree (Azadirachta indica A. Juss) such as leaves, bark, seeds etc. have been long known to have insect and disease control properties. The seed kernel in particular possesses the most active limonoids, such as Azadirachtins A and B and structurally related compounds such as Azadirachtins D, E, F, H, I, K, and the like, along with nimbin, salannin, azadiradione and the like. All the natural azadirachtins have been reported to have a very high growth disturbing activity against Epilachna varivestis, with LC₅₀s in the range of 0.3 to 2.8 ppm (H. Rembold and I. Puhimann, 1995. Azadirachtins: Structure and activity relations in case of Epilachna varivestis in The neem tree Azadirachta indica A. Juss. and other meliaceous plants sources of unique natural products for intergrated pest management, medicine, industry and other purposes p. 222-230 (Ed. H. Schmutterer VCH Publishers Inc., New York)) More than one hundred terpenoid compounds are reported from the neem seed/fruit of the neem tree. Azadirachtins A has been tested against more than 400 insects and found to be active as an antifeedant, insect growth regulation, ovicidal, and the like, thereby reducing insect population unlike neurotic insecticides. Being natural, they are highly degradable leaving no residues in the environment. Further, the neem components are reported to be safer to target organisms and mammals and hence ideal agents replacing conventional toxic agents used in crop and public health.

Various methods have been described to extract these active components from various parts of the neem tree in the crude or semi crude forms to be used in commercially acceptable vehicles in the form of liquid and solid formulations, such as powders, water dispersible granules, and the like. The crude neem seed extracts obtained after removal of lipid components normally comprises about 20-45 wt % of Azadriachtins A and B and have been shown to be potent insect growth regulators and feeding deterrents and form as potential active ingredients in commercial pest control formulations. These active molecules, however, are rather large and complex, and having acid and base sensitive functional groups, tend to be unstable when they come in contact with usual formulation ingredients, thus posing a major limitation for successful development of commercial formulations of these extracts in stable form.

So far, azadirachtins has been widely formulated in liquid forms to be applied as an emulsion or solution to agriculture crops. Various organic solvents and other inorganic additives have been used as carriers in order to make a cost effective and efficacious delivery system. The use of such carriers in commercial formulations is rather limited since many solvents are reported to be deleterious by causing degradation of azadirachtins. Dureja (1999) has studied the degradation of azadirachtin A in various solvents for 25 days at 29±1° C. (P. Dureja, Aditi Sinha, R. S. Tanwar and S. S. Tomar, 1999. “Stability of Azadirachtin—A in different organic solvents and aqueous solution” Pesticide research journal Vol. 11 (1) p. 90-92). The results indicated 50% degradation of azadirachtin A in methanol and acetone, 75-80% in methylene chloride, carbon tetrachloride and chloroform and about 85% in ethanol and water.

Storage-stable azadirachtins containing extracts and formulations, and methods of their preparation have been proposed.

U.S. Pat. No. 4,556,562 reports that the stability of azadirachtins in ethanol emulsions increased by diluting the concentration of azadirachtins to between 2000 and 4000 ppm and adjusting the pH to between 3.5 and 6.0.

U.S. Pat. No. 4,946,681 reports greater stability for azadirachtins in solutions of aprotic solvents containing less than 2-5% of water.

U.S. Pat. No. 5,001,146 indicates that azadirachtin stability is improved by adjusting the concentration of polar aprotic solvent to at least 50% by volume and by decreasing water content to less than 15% by volume.

U.S. Pat. No. 5,001,146 further indicates that azadirachtin stability depends upon the type of solvent employed, and that stability requires storage in certain enumerated aprotic and alcohol solvents.

U.S. Pat. No. 5,736,145 reports a storage stable aqueous composition containing azadirachtin A and U.S. Pat. No. 5,827,521 indicates a stable azadirachtin formulation containing aliphatic dihydroxylated alcohols of more than 80% by volume and optionally with sunscreens and antioxidants.

U.S. Pat. No. 5,352,697 describes the enhancement of stability of azadirachtins in solution by the presence of an epoxide, preferably an epoxidized vegetable oil. All of these methods describe the enhancement in stability of extracts containing azadirachtins in the liquid form prepared from neem seed kernel with organic solvents.

WO 92/16109 describes making an extract of neem seed in solid form with greater stability.

U.S. Pat. No. 5,635,193 reports that a solid containing azadirachtin is stabilized by limiting moisture and volatile polar solvents to less than 1% and 5% respectively. Higher stability is suggested for the extract if formulated with 0.05% to 2% surfactant and 99% of solid diluent (75% of azadirachtin after 2 weeks of storage at 54° C.). But no details were given with respect to the type of solid diluents and surfactants.

Preparation of stable neem seed extracts from the kernel of neem seed was reported in U.S. Pat. No. 5,695,763, European Patent No. 579,624, and Indian Patent No. 181,845.

Though various extracts with stable azadirachtins have been reported, shelf life for azadirachtins in a formulated state is still a concern. Azadirachtin is unstable in various surfactants, organic solvents, and in different combinations of solvent and surfactant in liquid formulations, which is a serious limitation for the development of a longer shelf stable commercial product.

Normal pesticide formulations contain various solvents made mostly from petroleum, and there is a concern that usage of such solvents in specialty pesticide formulations, especially meant for organic farming, veterinary applications, and the like, is discouraged. The use of such solvents, even at a lower rate, demands large amounts of surfactants and other additives which makes the cost of the formulations high. The use of a broader range of ingredients in liquid formulations and the associated problem of instability in such formulations is also a serious concern for the commercial success of azadirachtins containing crop protection agents.

Moreover, azadirachtins, especially Azadirachtin A, are highly photo labile and tend to degrade fast when applied on plant surfaces. The mode of action of azadirachtins in providing protection to plants against insects is quite different from the synthetic chemical molecules, the later of which act mostly due to their contact toxic property. The azadirachtins act as a repellent, antifeedant and growth regulator and hence they need to be exposed, absorbed, or entered into the insect systems for their control.

Borer type of insects and insects which have hard scale bodies are difficult to control through foliar application due to lack of contact. Compounds which possess systemic properties are ideal for control of such insects. Azadirachtins were reported to possess systemic properties and are readily absorbed by plants when applied to plant rhizosphere. Hence, a delivery system to deliver the azadirachtins into the plant rhizosphere will ensure effective protection of plants from borers as well as scaly sucking insects. Even though the aqueous emulsion of formulations containing azadirachtins can be applied to the soil, because of its total exposure to water and soil, it tends to degrade faster and this is unavailable for longer periods of protection. Hence, the effective and economical use of azadirachtins is not possible with any of the existing liquid formulations used for foliar applications. There is a need for an efficient delivery system to transfer azadirachtins to the plant rhizosphere without any significant loss of its content, and a need to release it slowly for plant protection. This can be fulfilled through a granular formulation, the type which has been used for delivering systemic plant protecting agents in agriculture and horticulture crops.

Granules are the most widely used and most versatile of the available pesticide delivery systems since their inception in the late 1940s. In these systems, the granules act as a diluent, as well as a carrier, for the plant protection agents. The large number of particles per unit weight of the granules allows the granules to be applied per unit area at a rate which is toxic to the pest but which will not cause damage to desirable life forms and undesired drifting. The available granule carriers are mostly of natural, both inorganic and botanical, and some are synthetic that are made from natural (botanicals) or synthetic components. But to be effective, they generally have properties of (a) adequate liquid holding/sorptive capacity (b) chemically inertness and (c) free flowing.

The inorganic category of carriers include clays, attapulgite, bentonite, kaolin, sepiolite, kieselguhr, diatomaceous earth, talc, brick fragments sand, white carbon, and vermiculite. The botanical category comprises corn cobs, walnut shells, rice hulls, wood, starch, natural plant fibers, and pumice, and can be of distinct particles within the range of 180 to 4750 mesh size (microns). While low in cost, the clays often times need to be treated with a deactivator prior to adding to the formulation to prevent decomposition of the active ingredient. Corn cobs have been a primary source of inert granular carriers, but their extensive use and the consistent availability affected by occasional drought conditions can lead to an inadequate supply, and can be a costly alternative.

The effectiveness of the granule product is dependent not only upon the nature of active ingredient but also upon the nature of inert ingredient used as the carrier which acts as the transfer mechanism for the active ingredient. If the carrier does not effectively release the active ingredient, the active compound will never reach its intended target. Importantly such a carrier should be inert to active ingredients and should also not cause degradation to active ingredients.

Thus, selection of an effective carrier is an essential step in the development of a successful granular formulation. It is indeed a critical task to choose a suitable carrier for azadirachtins due to its highly reactive nature with acidic/ basic sources and due to the ionic nature of these carriers and other additives used in the granulation.

The Applicant has tested the suitability of conventional carriers such as silica, bentonite, clay etc. for azadirachtin granular formulations. It is observed that azadirachtins are highly susceptible to undergo rapid degradation in contact with these carriers when formulated in a conventional manner. This limits the use of these carriers directly for formulations containing azadirachtins. Further, since azadirachtins are readily soluble in water, normal methods of impregnation with these carriers without binders result in the immediate release of azadirachtin into the soil as soon as it comes in contact with water, which is undesirable. The use of known binders, such as polyvinyl alcohol, rosin, pressmud, wax, sugar, and clay, along with such carriers as silica and bentonite have limitations as they have caused rapid degradation to azadirachtins.

Accordingly, there is a need to identify solid carriers that provide improved stability to azadirachtins and that are capable of delivering the azadirachtins, as desired into the plant rhizosphere.

As azadirachtin molecules are thermo-labile, extrusion methods to prepare granular preparations use several ingredients, such as emulsifiers, polymers, binders, drying agents etc. and use rather high temperatures during extrusion, which will lead to degradation during the process.

Hence, various granulation processes described in the prior art which are mostly suitable to synthetic chemical molecules are not ideal for bio-molecules such as azadirachtins with the available carriers and additives.

Various prior art methods described the preparation of granular pesticide formulations based on two different processes. 1. Extrusion granulation process, involving the blending of active ingredients, with various additives such as waxes, surfactants, polymers, inorganic salts etc, melt/ mixing in water and extruding the fluid through a die to form granules of desired diameter. The extrudate is then fed into a dryer to reduce the moisture content of the granules to yield free flowing product. 2. Spray formulation process, in which, the pesticide is dissolved in an appropriate solvent or molten state and is sprayed onto the inert particles.

One of the important features of the granular formulation is its ability to release the pesticide active compound in a controlled manner. Several prior art methods were known to achieve the controlled release of active substances from granulated forms by an encapsulation process. The encapsulation involves coating particulate matter for releasing of an active agent over a prolonged period. Such processes have been developed based upon the use of organic polymers of non-polymeric organic materials, such as fats and waxes, as the coating material. Typical processes are described, for example, in U.S. Pat. Nos. 2,800,457, 2,800,458, 3,415,758, 3,429,827, 3,594,327, 3,639,256, and 3,674,704.

It is well known that biocidal materials can be incorporated into an elastomer matrix and release at a rate efficacious with pest destruction. U.S. Pat. No. 3,417,181 teaches that organotin toxicants can be dissolved in an elastomer-type matrix and release through a diffusion-dissolution mechanism when exposed to water. The bio-active agents, such as organic pesticides, are soluble in elastomers such as natural rubber, styrene-butadiene rubber etc. (U.S. Pat. Nos. 3,590,119, 3,426,473, 3,851,053, and 3,639,583).

Prior art methods are known to cause an insoluble organic agent to emit from a plastic dispensing unit by using a third phase material that is (a) soluble to some extent in the plastic, and (b) will carry the organic agent in solution or serve as a migratory pathway for the agent to reach the surface of the dispenser. To achieve these complex properties to the granules, it may require varied chemicals and conditions such as emulsification, polymerisation, cross linking, and the like, using inorganic salts, bases, acids, organic solvents, polymers, and the like. (U.S. Pat. Nos. 2,956,073, 3,116,201, 3,705,938, and 3,864,468).

Pesticide granules have been prepared by both macro and micro encapsulation processes, placed in ceramic materials, included in biodegradable polymers, mixed with porous mineral supports, coated with cellulosic derivatives, combined with poly-urea compounds, and included with gypsum and other supports to protect the pesticide from the environment and to ensure a controlled release in an attempt to substantially control pest populations.

In addition to the above patents, the following patents refer to either the granular formulation comprising azadirachtins and/or its process for preparation. U.S. Pat. Nos. 4,065,558, 4,341,759, 4,370,160, 4,464,317, 4,485,103, 4,732,762, 4,971,796, 5,130,171, 5,229,356, 5,435,821, 5,484,600, 5,556,631, 5,562,914, 5,945,114, 6,090,415, EP Patent Nos. 0200288, 0848906, 0966882, GB Patent No. 2127690, IN Patent No. 189,080, WO 02/05641, 02/087342 and 94/09627.

TABLE
Some Prior-art methods for preparation of different types of granular formulations.

| Patent No | | | LIMITATIONS |
|---|---|---|---|
| 1. U.S. Pat. No. 4,065,558 | ACTIVE | Phosphorodithioate | Rapid release of |
| Gordon et. al | INGREDIENT | | azadirachtin and |
| | TYPE | Coating/ | degradation on |
| | | Impregnation on to inert carriers | storage |
| | CARRIERS | Diatomites, clay, kaolin, attapulgive, | |
| | | ground corn cobs, sand, ground | |
| | | limestone, silica, activated carbon | |
| | ADJUVANT | Polyols as deactivators | |
| | CONDITIONS | Coating | |
| | APPLICATION | Soil application | |
| 2. U.S. Pat. No. 4,341,759 | ACTIVE | Drug/pesticides | Complex and |
| Bogentoft, et. al | INGREDIENT | | expensive process |
| | TYPE | Coated Granules | |
| | CARRIERS | Sugar | |
| | ADJUVANT | Talcum, aerosil, ethyl cellulose, acetyl | |
| | | butyl citrate, methylmethacrylate, | |
| | | ethylacrylate etc. | |
| | CONDITIONS | Continuous spraying of a.i. solutions of | |
| | | varied ocnentrations | |
| | APPLICATION | Controlled release of a.i. | |
| 3. U.S. Pat. No. 4,370,160 | ACTIVE | Biocide | Active Siloxane |
| Ziemelis | INGREDIENT | | sites cause |
| | TYPE | Microencapsulation | degradation to |
| | CARRIERS | Organopolysiloxane | azadirachtin. |
| | ADJUVANT | Mercaptopropyl containing | Process too |
| | | polydiorganosiloxane, | complex and |
| | | cyclopolydimethylsiloxoanes, | expensive |
| | | hexamethyldisiloxane, | |
| | | cyclopolymethylmercaptopropylsiloxane, | |
| | | sodium carbonate, etimethylsiloxane, | |
| | | mineral oil | |
| | CONDITIONS | 70 Deg C., & UV radiation | |
| | APPLICATION | Pesticide/ | |
| | | herbicide formulations | |
| 4. U.S. Pat. No. 4,464,317 | ACTIVE | Furadan | The adjuvants are |
| Thies, et al | INGREDIENT | | known to degrade |
| | TYPE | Encapsulation | azadirachtin. |
| | CARRIERS | | Unsuitable for |
| | ADJUVANT | Sodium silicate/calcium chloride, water | treatment at |
| | CONDITIONS | Encapsulation over 12 days | rhizosphere due to |
| | APPLICATION | Pesticide | low density of |
| | | | capsules. |
| 5. U.S. Pat. No. 4,485,103 | ACTIVE | Phosphorodithioate | Montmorillonite are |
| Pasarela | INGREDIENT | | known to degrade |
| | TYPE | Coating/impregnation | azadirachtin |
| | CARRIERS | Montmorillonite | |
| | ADJUVANT | Deactivators, acrylic emulsion | |
| | CONDITIONS | Spraying and blending | |
| | APPLICATION | Soil application | |
| 6. U.S. Pat. No. 4,732,762 | ACTIVE | Encapsulated mosquito control agent | Complex and |
| Sjogren | INGREDIENT | | expensive process |
| | TYPE | Extrusion | |
| | CARRIERS | | |
| | ADJUVANT | Water, Charcoal, dental plaster | |
| | CONDITIONS | Molding the slurry | |
| | APPLICATION | Water treatment | |
| 7. U.S. Pat. No. 4,971,796 | ACTIVE | Encapsulated mosquito control agent | Direct contact of |
| Sjogren | INGREDIENT | | sand and collagen at |
| | TYPE | Granules | moist conditions |
| | CARRIERS | #30 Red Flint filter sand | cause degradation |
| | ADJUVANT | Collagen protein, water, Charcoal | to azadirachtin. |
| | CONDITIONS | Alternate coating of a.i. and charcoal | |
| | | over sand | |
| | APPLICATION | Water treatment | |
| 8. U.S. Pat. No. 5,130,171 | ACTIVE | Catalyst/pesticide/seeds/drug/colorant | Complex and |
| Prud'Homme, | INGREDIENT | | expensive process. |
| et. al | | | Adjuvants degrade |
| | | | azadirachtin |
| | TYPE | Encapsulation by spraying | |
| | CARRIERS | | |
| | ADJUVANT | Alpha, omega- | |
| | | dihydropolydimethylsiloxane, 12- | |
| | | dichloroethane | |
| | CONDITIONS | 50 Deg C. | |
| | APPLICATION | Control release application | |
| 9. U.S. Pat. No. | ACTIVE | N-[[4,6-dimethoxy-2-pyrimidinyl)- | High temperature is |
| 5,229,356 | INGREDIENT | amino]carbonyl]-1-methyl-4-(2-methyl- | deleterious to |
| Tocker | | 2H-tetrazole-5yl)-1H-pyrazole-5- | azadirachtin |
| | | sulfonamide | |
| | TYPE | Granules by extrusion | |
| | CARRIERS | | |
| | ADJUVANT | Wax | |
| | CONDITIONS | Melting a.i. and wax 100 Deg C. and | |
| | | allow it to solidify | |
| | APPLICATION | Slow release herbicide | |
| 10. U.S. Pat. No. | ACTIVE | Vegetation enhancement agent/pesticide | Sulfonated are |
| 5,435,821 | INGREDIENT | | active groups |
| Duvdevani, | TYPE | Coating | known to degrade |
| et al | CARRIERS | | azadirachtin |
| | ADJUVANT | A sulfonated polymer in toluene/ | |
| | | isopropanol | |
| | CONDITIONS | Drying in hot stream | |
| | APPLICATION | Seed/fertiliser treatment | |
| 11. U.S. Pat. No. | ACTIVE | Bacillus thuringiensis | Azadirachtin shown |
| 5,484,600 | INGREDIENT | | degradation when |
| Sjogren | TYPE | Granules | applied directly to |
| | CARRIERS | Texas 12/20 Sand | sand as per the |
| | ADJUVAN | Dicaperl, Morwet EFW, Glycerin, Fish | process |
| | | gelatin | |
| | CONDITIONS | Blend the a.i premix and adjuvant mix | |
| | | to obtain a.i. impregnated granules | |
| | APPLICATION | Aquatic insects | |
| 12. U.S. Pat. No. | ACTIVE | | Not appropriate for |
| 5,556,631 | INGREDIENT | | agriculture |
| Kelley | TYPE | Baits/granules | application |
| | CARRIERS | Sucrose, Corn cobs, Aqsorb, Peanut | |
| | | hull, Biodac (paper), diatomaceous earth | |
| | ADJUVANT | Sorbital tristearate, Acetylated sucrose | |
| | | distearate, Glycerol trioleate, | |
| | CONDITIONS | Mix the ingredients and heat up to 70 | |
| | | Deg C. | |
| | APPLICATION | Household insects | |
| 13. U.S. Pat. No. | ACTIVE | Liquid pesticide | Clay is not a |
| 5,562,914 | INGREDIENT | | suitable carrier to |
| Scher, et al | TYPE | Granules | azadirachtin |
| | CARRIERS | Porous clay | |
| | ADJUVANT | Polyurethan matrix of a polyol and a | |
| | | polyisocyanate | |
| | CONDITIONS | Spraying liquid a.i. and additives | |
| | APPLICATION | Plant protection | |
| 14. U.S. Pat. No. | ACTIVE | Pesticide | Active sites of |
| 5,945,114 | INGREDIENT | | Silica degrade |
| Ogawa, et al | TYPE | Despersible granules | azadirachtin |
| | CARRIERS | Hydrated silica | |
| | ADJUVANT | Surface active gents | |
| | CONDITIONS | Wet granulation, comaction | |
| | APPLICATION | Plant protection | |
| 15. U.S. Pat. No. | ACTIVE | Pyrethroids | Sulfur is known to |
| 6,090,415 | INGREDIENT | | degrade |
| Stadler et al. | TYPE | Admixing sulfur granules and a.i. | azadirachtin. |
| | | impregnated carrier/Water dispersible | Delivery system is |
| | | granules | suitable only for |
| | CARRIERS | Silica/Sulphur | foliar application |
| | ADJUVANT | Sodium lignosulphate, nonylphenol, | |
| | | silicon | |
| | CONDITIONS | Spray drying/blending/melting | |
| | APPLICATION | Insects and ectoparasites by surface | |
| | | spray | |
| 16. EP 0200288 | ACTIVE | Disulfuton | Process conditions |
| Amburgey | INGREDIENT | | and adjuvants cause |
| William | TYPE | Briquette | degradation to |
| | CARRIERS | Attapulgite | azadirachtin |
| | ADJUVANT | Thermosetting resin | |
| | CONDITIONS | >100 Deg C. | |
| | APPLICATION | Aquatic insects | |
| 17. EP 0848906 | ACTIVE | Hardly water soluble ingredients | A large number of |
| Kimoto | INGREDIENT | | ingredients which |
| Narutoshi, | TYPE | Surface coating | possesses active |
| et al | CARRIERS | Bentonite, clay, kaolin, rice hust etc. | sites and high |
| | ADJUVANT | Gums, rosins, carboxy methyl cellulose, | temperature makes |
| | | olefinic polymers, diene copolymers, | azadirachtin |
| | | butadiene polymers, bees wax, haze wax | unstable |
| | | and paraffins etc. | |
| | CONDITIONS | 100-160 Deg C. | |
| | APPLICATION | Pesticides | |
| 18. EP0966882 | ACTIVE | Pesticide | Several ingredients |
| Kimoto | INGREDIENT | | make the |
| Narutoshi, | TYPE | Extrusion/impregnation/coating | formulation very |
| et al. | CARRIERS | Zeolite/talc/clay/bentonite, | expensive |
| | | diatomaceous earth, calcium carbonate | |
| | ADJUVANT | Binders-gum arabic, carboxy methyl | |
| | | cellulose etc. | |
| | | Resin-olefin polymers, diene polymers, | |
| | | waxes, petroleum resins, natural resins | |
| | CONDITIONS | Single layered coating | |
| | APPLICATION | Time released pesticide | |
| 19. GB2127690 | ACTIVE | | Not suitable for soil |
| Shieh | INGREDIENT | | application |
| Tsuong Rung | TYPE | Coating | |
| | CARRIERS | Wax/corncobs | |
| | ADJUVANT | | |
| | CONDITIONS | a.i. coating over wax or wax coated corn | |
| | | cob base wax | |
| | APPLICATION | Aquatic application to control mosquito | |
| | | larvae | |
| 20. IN 189,080 | ACTIVE | Azadirachtin | Carriers and |
| Shah Deepak | INGREDIENT | | adjuvants cause |
| Pranjivandas, et | TYPE | Water dispersible granules | degradation |
| al | CARRIERS | Clay, silica, sodium hypochloride, | azadirachtin during |
| | | bentonite etc | storage |
| | ADJUVANT | Lignin deriviatives, alkyl aryl sulfonic | |
| | | acid etc | |
| | CONDITIONS | Spray drying of suspension of ai, | |
| | | carriers and adjuvants | |
| | APPLICATION | Foliar application | |
| 21. WO | ACTIVE | Herbicides/fungicides/insecticides | Extrusion process |
| 0205641 | INGREDIENT | | conditions such as |
| Kitagaki | TYPE | Extrusion of a.i. and coating with a | high temperature |
| Kenichi | | thermoplastic polymer | etc. cause |
| | CARRIERS | | degradation of |
| | ADJUVANT | | azadirachtin |
| | CONDITIONS | | |
| | APPLICATION | Pesticide | |
| 22. WO | ACTIVE | Bt. Endo toxin | Complex process. |
| 02087342 | INGREDIENT | | Azadirachtin |
| Zomer Eliezer | TYPE | Granules | degrades at molten |
| | CARRIERS | Perlite, Vermiculate | temperature of wax. |
| | ADJUVANT | Molten wax, sunscreens, paper sludge, | |
| | | cellulose, wetting agents etc | |
| | CONDITIONS | Granulation in molten wax and other | |
| | | adjuvants | |
| | APPLICATION | Larvicide | |
| 23. WO | ACTIVE | Water soluble, PGRs, pesticides, | Water and |
| 9409627 | INGREDIENT | Herbicides | temperature are |
| Fersch Ken, et al | TYPE | Dispersible granules | deleterious to |
| | CARRIERS | Absorptive carriers | azadirachtin |
| | ADJUVANT | Water, Wetting agents, surfactants | |
| | CONDITIONS | Impregnation of ai on carrier/granulation | |
| | | by extrusion and drying | |
| | APPLICATION | Plant protection | |

The above prior art documents have been considered in their entirety in the present application. It is also clear from the details furnished in the above table that there are limitations associated with both the prior art compositions comprising azadirachtin and the process for the preparation of these compositions. The present invention has provided a composition comprising azadirachtin and a process for the preparation of the composition by overcoming the limitations of the prior art.

Thus, there is a need for an effective and stable granular formulation of neem seed extract containing azadirachtin and a process to obtain azadirachtin based granules in stable form. This objective has been achieved by the Applicant by providing an improved granular formulation comprising neem seed extract containing azadirachtin for the purpose of protecting plants from insect damage when applied at the plant rhizosphere. The improved granular formulation has enhanced storage stability and has the ability to permit the gradual release of active principle azadirachtin from the granules. Also, the carrier used to achieve the efficient granular formulation is an easily available solid material, found compatible with the thermolabile azadirachtins when coated with a liphophilic substance.

The surprising results of the present invention provide a combination of enhanced storage stability and gradual release of azadirachtin in a formulation containing neem seed extract by using a lipophilic substance which preferably imparts the characterstic of deactivator and binder which has never been achieved in the prior art granular formulations.

### OBJECTS OF THE INVENTION

An object of the present invention is to provide an improved granular formulation of neem seed extract essentially comprising Azadirachtin for the purpose of protecting plants from insect damage.

Another object of the invention is to provide a granular formulation which can be applied to a plant rhizosphere.

Yet another object of the invention is to provide a granular formulation having enhanced storage stability.

Still another object of the invention is to provide a granular formulation which releases gradually Azadirachtin when applied to a plant rhizosphere.

Another object of the invention is to provide a granular formulation for systemic application.

Still yet another object of the present invention uses a lipophilic substance as a deactivator to protect the azadirachtin from degrading due to its contact with the carrier.

Still another object of the invention is to provide a lipophilic substance as a binder acting as a permeable membrane for establishing the contact between water and neem seed extract used.

Another object of the invention is to provide a formulation in which the neem seed extract containing azadirachtin is sandwiched between the impregnated inert particulate and a lipophilic substance containing coating.

Yet another object of the invention is to provide a safe, bio-degradable and environmental friendly formulation.

Still yet another objective of the invention is to provide a substitute for toxic and persistent chemical plant protecting agents.

Still another object of the invention is to provide a solid carrier modified by coating with a lipophilic substance to enhance the stability of azadirachtin from the neem seed extract used in the formulation.

Still yet another object of the invention is to provide a carrier and other ingredients which are of natural origin, environmentally safe, and inert to achieve desired activity.

### SUMMARY OF THE INVENTION

The present invention relates to an improved granular formulation containing neem seed extract and having enhanced storage stability, and/or the ability to gradually release azadirachtin for application to the plant rhizosphere. The formulation comprises silica (e.g., sand) as a carrier, at least one lipophilic substance as a binder, an optional colorant, and azadirachtin containing neem extract. The formulation preferably provides the release of azadirachtin gradually and effectively at the point of application. The invention also relates to a process for the preparation of the formulation by coating the carrier with a lipophilic substance, subsequently impregnating the coated carrier with neem seed extract, optionally followed by coating with a colorant, and finally applying an additional lipophilic substance, such as by spraying, and then drying, such as at a temperature of up to 50° C.

It is to be understood that both the foregoing general description and the following detailed description are exemplary and explanatory only and are intended to provide further explanation of the present invention, as claimed.

Description of Tables:

Table 1—Formulation recipe and percentage Azadirachtin release in water run test.

Table 2—Stability data of Azadirachtin.

Table 3—Mortality of BPH fed on rice seedlings treated with the granular formulations.

Table 4—Monitoring of systemic absorption of Azadirachtin in rice seedlings

### DETAILED DESCRIPTION OF THE PRESENT INVENTION

In accordance with the objective, the present invention describes an improved granular formulation having enhanced storage stability and/or having a controlled release of Azadirachtin on application to the plant rhizosphere to prevent plants from insect damage. The composition comprising of:

| Ingredients | Wt./Wt(%) |
|---|---|
| i. Neem seed extract | 0.03 to 50.00 |
| ii. Carrier (e.g. solid) | 48.50 to 99.30 |
| iii. Colorant (optional) | 0.00 to 0.4, such as 0.01 to 0.04 |
| iv. Lipophilic substance | 0.50 to1.50 |

In an embodiment of the present invention, a preferred granular formulation comprises:

| Ingredients | Wt./Wt(%) |
|---|---|
| 1. Neem seed extract | 0.075 to 12.50 |
| 2. Carrier | 86.70 to 99.20 |
| 3. Colorant | 0.02 to .0.03 |
| 4. Lipophilic substance | 0.60 to 0.75 |

Another embodiment of the invention provides a process for preparing a granular formulation, wherein the process comprising steps of:
a) washing optionally the carrier with water, drying, such as at about 60° C., sieving to obtain dried carrier,
b) coating the dried carrier of step (a) with at least one lipophilic substance, such as dissolved in a solvent, such as an organic solvent,
c) impregnating the coated carrier of step (b) with neem seed extract, such as dissolved in a solvent, drying, such as drying in a stream of hot air, such as at a temperature ranging from 40° C. to 50° C.,
d) optionally coating with at least one colorant, for instance dissolved in a solvent, and applied, such as by spraying the step (c) impregnated material, and then drying, such as at about 40° C. to below 50° C., and
e) coating finally the material of step (d) with at least one lipophilic substance, and drying, such as at about 40° C. to up to below 50° C., to obtain the required granular formulation.

The invention uses neem seed extract ranging from 0.03 to 50 wt %, by weight of the formulation. The need seed extract contains azadirachtin(s).

The azadirachtin content in the neem seed extract is preferably present in an amount of up to 1.0 wt % by weight of the neem seed extract. The carrier used can be silica. The carrier can be selected from sand, such as from rocks, minerals, shells, corals, precipitates or synthetic or sourced from river banks, beaches, sand dunes, deserts or volcanic deposits. The preferred carrier used is river sand. The particle size of the carrier, such as silica, can range from 500 to 1400 mesh size (microns), preferably 500 to 1000 mesh size (microns). The moisture content of the carrier, such as silica, used can be up to below 2.0 wt % based on the weight of the carrier. The lipophilic substance used for coating is selected from waxes of natural or synthetic origin, preferably beeswax and paraffin wax. The colorant used is selected from the group consisting of synthetic and natural substances such as crystal violet, methyl violet, natural bixin turmeric, and mixtures thereof.

Organic solvent(s) can be used for dissolving the lipophilic substance, such as low boiling hydrocarbons, ethers, ketones, aldehydes, esters, such as n-hexane, petroleum ether, diethyl ether, acetone, ethylacetate and the like.

The neem seed extract used can be dissolved in a solvent such as selected from the group consisting of ethers, ketones, alcohols, aldehydes, esters such as diethylether, ethylacetate, acetone, and methanol and the like.

The azadirachtin containing neem extracts can be prepared from neem seed and used for intended application as a plant protection agent. Since azadirachtin controls pest not through contact toxicity but through insect growth regulating properties and possesses systemic properties, it can be effectively used with a delivery system, usually in solid granular form, which makes the plant absorb azadirachtin when the granules are applied to the plant rhizosphere. Insects, such as borers and sucking in nature with hard scaly bodies, are also effectively controlled with such a method which achieves azadirachtin entry into the insect when they feed on the granule treated plants. Conventional liquid azadirachtin formulations fail to control these insects effectively when they are applied on plants as sprays.

As azadirachtin is highly reactive to various carriers due to its acidic or basic nature and ionic nature, selection of suitable carriers is critical for the development of a stable granule formulation. Various processes which involve encapsulation or blending of various ingredients and making granules by extrusion are rather complex and require costly equipment and ingredients which make the product very expensive. These processes also have limitations for use with azadirachtin as they use drastic process conditions, such as high temperatures, melting of various ingredients, and use chemicals such as surfactants, polymers, proteinaceous materials, pH modifiers, ionic solvents, water, and the like, which are highly detrimental to azadirchtin causing degradation in the process.

With an intention to develop a simple and cost effective granular formulation for azadirachtin containing neem extract, agriculturally accepted carriers were tested, such as silica, bentonite etc. Granulation was carried out by spraying the solutions of azadirachtin containing neem extract dissolved in different solvents such as ethyl acetate, methanol, cyclohexanone, and the like. Evaluation of the stability of azadirachtin in these formulations under standard accelerated conditions at 54° C. indicated higher degradation of azadirchtin which made these carriers unsuitable if formulated by methods hitherto known. Further, with azadirachtins being highly soluble in water, their release in water is rather rapid, which is undesirable for an ideal granular formulation. Several formulations using cheaper carriers were made, such as sand, bentonite, and various additives. These formulations were studied for their stability and release of azadirachtin when in contact with water. The limitations noticed for azadirachtin thus surprisingly got answered while studying the phenomenon of the release of azadirachtin coated on sand granules with lipophilic substances used as a binder. One of the formulations provided higher stability to the azadirchtin which can involve the following process.

The natural river sand available locally in India is procured and cleaned with water to free it from mud and low density impurities. The dried sand was sieved to obtain particles with a 500 to 1000 mesh size (microns).

The sand was coated with a lipophilic substance, preferably beeswax or paraffin wax, such as 1 wt %, preferably 0.5 wt %, most preferably 0.25 wt % by weight of the formulation, which was dissolved in a lipophilic solvent, such as hydrocarbons by any normal method of spraying or by direct contact of the wax solution with sand granules. The hydrocarbon used for dissolving wax can be selected from lower hydrocarbons, hexane, petroleum ether, and the like, such as with a boiling point around 60-80° C. The wax impregnated granules are dried under the current of hot air up to below 50° C. to obtain free flowing particles. The wax impregnated sand particles thus obtained are treated with azadirachtin containing neem extract equivalent to 1.2 wt % azadirachtin, most preferably 0.1 wt % azadirachtin dissolved in a suitable solvent. The solvent used for dissolving azadirachtin containing neem extract may be of medium to polar in nature such as esters, alcohols, ketones, aldehydes, and the like. Preferred solvents are ethyl acetate, methanol, and acetone. The application of the azadirachtin containing neem extract solution to the wax coated granules may be accomplished by direct treatment or by spraying or blending and then can be dried under a current of hot air, preferably up to below 50° C. or under vacuum to obtain free flowing granules. The azadirachtin coated particles thus obtained are further treated with the lipophilic substance, preferably beeswax or paraffin wax, such as at 1 wt %, preferably 0.5 wt %, most preferably 0.25 wt % (based on the weight of the formulation) which can be dissolved in a lipophilic solvent, such as hydrocarbons. The dissolved lipophilic substance can be applied by any conventional method, such as spraying or by directly contacting the wax solution with the sand granules. The hydrocarbon used for dissolving wax is selected from lower hydrocarbons, hexane, petroleum ether, and the like, preferably having a boiling point around 60-80° C. The resultant granules are dried by conventional drying methods, which can remove bound solvents, preferably up to below 50° C. and/or under vacuum. The granules thus obtained retain azadirachtin without any change during the process of their preparation and possess higher storage stability and permit the gradual release of bio-active compounds (e.g., 10-15% as observed in ‘water run-off test’) at the application site and give desired activity for its intended use.

The amount of bio-active compounds present in the granule formulation can be any amount effective to have intended activity, such as, but not limited to, reducing or eliminating insect damage to trees and/or crops. Preferably the amount of azadirachtins present in the pesticide formulation is from about 0.03 weight % to about 5.0 weight % based on the weight of the granule formulation, and more preferable from about 0.03 to about 1.0 weight % based on the weight of the granule formulation. In terms of the neem seed extract, the neem seed extract is preferably present in an amount, ranging from about 0.075 to about 50.0 w/w % of pesticide granular formulation. Most preferably, the azadirachtins present in the pesticide formulation ranges from about 0.03 to 5.0 w/w %.

The method for producing the bio-active compounds, such as azadirachtin, can be achieved as described in U.S. Pat. No. 5,695,763, which is incorporated herein in its entirety. In general, the azadirachtin can be recovered preferably from the seeds of a neem tree by crushing the seeds and then extracting the azadirachtins and other active ingredients from the crushed seeds with water. The extraction of azadirachtin and other active ingredients from the water can be accomplished using a non-aqueous solvent which is not miscible with water and has a high solubility of azadirachtin than water, or by using a surfactant having a turbidity temperature between 20° and 80° C. The concentrated azadirachtin is then recovered from the second extracting solution. The azadirachtin containing solution can then be concentrated to produce a concentrate containing azadirachtin which is added to a liquid hydrocarbon, thus forming a precipitate comprising azadirachtin which is then recovered for use in pesticide formulations. The method described in Indian Patent No. 181,845 can also be adopted for the preparation of neem seed extracts comprising azadirachtin. The azadirachtin can also be recovered according to the methods described in U.S. Pat. Nos. 5,124,349 and 5,397,571. In one method, a neem extract is prepared by de-fatting coarsely ground neem seeds with a non-polar solvent followed by extraction of azadirachtin from de-fatted neem seeds using a polar aprotic solvent. The process described in U.S. Pat. No. 5,397,571 involves extracting ground neem seeds with a co-solvent mixture of a non-polar and a polar solvent to obtain a neem extract having both the hydrophilic azadiracthin containing portion and the hydrophobic neem oil portion of the seeds. The resultant hydrophobic and hydrophilic extracts are concentrated by removing respective solvent to obtain ‘neem extract’ containing azadirachtin and other lipophilic components. The neem extract is then treated with a low polar solvent to precipitate the azadirachtin-containing portion of the extract. The solid is separated by filtration, dried to obtain about 10-20 wt % of azadirachtin in it. Other conventional methods which involve crushing, solid liquid extraction, chromatography, precipitation and like may also be used for the preparation of neem seed extract containing azadirachtin.

With respect to the lipophilic organic substances used in the present invention, examples include beeswax, or paraffin wax preferably paraffin wax which is about 2% weight % or less by weight of the granule formulation and preferably 0.25-1.0 weight % by weight of the granules.

With respect to the carriers, examples include sand, preferably natural sand, and its chemically related particles, most preferably river sand of 500 to 1000 mesh size (microns). The moisture content of the sand or other carrier can preferably be up to 2 wt %, based on the weight of the carrier. Other moisture contents can be used.

The granule formulation may additionally be made distinguishable by incorporating a colorant. The colorants may be natural or synthetic, and may be pigment based or dye based. Examples of synthetic compounds include crystal violet, methyl violet, brilliant blue, indigo carmine, erythrosine, allura red, tatrazine, sunset yellow, fast green, carmosine, ponceau 4R, cochineal red A, red 2G, green S, brown HT, brilliant black BN, Iron oxides, quinoline yellow, lithol rubine BK, and the like. Examples of natural colorants include curcumin, lutein, carotenes, lycopene, carmine, betanin, anthoxyanin, chlorophyll, carbon black, bixin, capsanthin, and the like. The weight percent of colorant can be less than 1 wt % and most preferably 0.05 wt % by weight of the granule formulation. The colorant can be incorporated before the final coating of wax. The colorant can be dissolved in methanol or ethyl acetate and sprayed over neem seed extract coated granules, dried under the current of air below 50° C. and/or under vacuum.

The granular formulation described herein can be prepared by conventional mixing/blending techniques such as spraying or direct addition of various ingredients to the solid carrier using appropriate conventional equipment. Preferably, the lipophilic substance is dissolved in a hydrocarbon solvent, preferably in hexane and sprayed or added to the sand granules or other carrier before and/or after treatment of the azadirchtin containing neem extract. The solution of azadirchtin containing neem extract is prepared by dissolving in an appropriate solvent, preferably in low boiling polar solvents, such as acetone, ethyl acetate, and the like, and then sprayed or applied directly over lipophilic coated sand or other carrier particles. The drying of coated granules at the end of each stage of application of lipophilic substance, azadirachtin containing neem extract, and optional colorant can be carried out at any temperature, such as a temperature below 50° C. and/or under vacuum.

The granular azadirachtin formulation of the present invention on analysis has shown the retention of azadirachtin content without any change during the manufacturing process.

The granular azadirachtin formulations described herein are preferably storage stable which is evidenced by subjecting the formulation to accelerated heat degradation. For instance, 85% by weight of the azadirachtin originally present remains after 28 days of storage at 54° C. in a sealed container which is equivalent to two years of shelf life at an average storage condition of 25 Deg C.

Further, the granular azadirachtin formulation of the present invention meets the desired specification of a commercial agrochemical granular formulation that such granules preferably release the active ingredient less than 15% (by weight) of its nominal value in 10 minutes when the granules are brought in contact with water. Thus, the present invention provides a cost effective process for the preparation of azadirachtin granular formulations by using very minimal ingredients and less costly equipment and provides a higher stability to azadirachtin during the process and post process storage; and releasing the azadirachtin in quantities which are sufficient for bio-activity and meeting granular specifications in general.

The ability of the granule formulations of the present invention to contain all natural substances and yet be storable for longer periods has advantages over commercially available other liquid formulations since in many specialty applications, the use of organic solvents is discouraged due to environmental concerns.

The above mentioned features of the present invention thus make the process and product unique for successful commercial applications.

Additional features and advantages of the present invention will be set forth in part in the description which follows, and in part will be apparent from the description, or may be learned by practice of the present invention. The objectives and other advantages of the present invention will be realized and obtained by means of the elements and combinations particularly pointed out in the written description and appended claims.

To achieve these and other advantages, and in accordance with the purpose of the present invention, as embodied and broadly described herein, the present invention relates to a granular formulation of azadirachtin containing neem extract comprising sand or other material as a carrier, at least one lipophilic substance as a deactivator and binder, and one or more bio-active compounds, such as azadirachtin and other limonoid containing neem extracts.

The following examples are for the purpose of illustration of the present invention and should not be construed to limit the scope of the present invention.

### EXAMPLES

### Example I

Encapsulation of Azadirachtin in Granular Formulation

Neem seed extracts containing azadirachtins is formulated in granular formulations using various carriers, binders/additives. The critical parameters of encapsulation and stability of active ingredients are evaluated using suitable methods in order to identify ideal carriers and binders for the neem seed extract.

The extent of encapsulation of azadirachtins in all these formulations is determined according to a ‘water run-off test’ as per the method prescribed in Bureau of Indian Standard specification IS: 6940-1982. According to the method, 10 g of the granules are taken into a 100 ml burette plugged with cotton, and 50 ml water is added to the granules. Water is collected from the burette after 15 minutes and analyzed for azadirachtin content by HPLC as per the method prescribed in Bureau of Indian Standard specification IS: 14299-1995. The percentage of release of azadirachtin from the granules is given in Table 1.

A. Neem Seed Extract Granules Prepared by Conventional Methods

Granular formulations 1 and 2 of azadirachtin containing neem extract are prepared by a conventional manner as follows. 474 g of sand particles are mixed with 20 g of white clay in a 2 liter conical flask. 1 g of polyvinyl acetate is dissolved in 15 ml of boiling water to which is added 1.22 g (eq. to 0.1% azadirachtin neem seed extract, noigen—1.16 g, crystal violet—0.15 g and sugar—5 g. The contents are thoroughly mixed to obtain a clear solution. The solution is then added slowly to the sand-clay mixture while stirring the contents thoroughly. After the addition is completed, the wet granules are transferred onto a glass tray and dried at a temperature up to below 50° C. for 8 hrs (Formulation 1).

The granules are subjected to the water ‘run-off test’ to find out the extent of encapsulation. The results indicated a 90% release of azadirachtin from the granulated product. The granules used for insect control generally released about 15 wt % of their active ingredient when subjected to this test.

To further improve the encapsulation in Formulation 1, the granules were coated with beeswax as described below.

1.25 g of beeswax was dissolved in 15 ml of n-hexane. The wax solution was added drop wise to 250 g of above granules taken in a I liter conical flask. The contents were thoroughly mixed for few minutes and transferred into a glass tray and dried under a current of air or in hot air at a temperature below 50° C. for 2 hrs (Formulation 2). The resulting wax coated granules were subjected to a water runoff test. The results indicated a 72% release of azadirachtin, which is a slight improvement compared to granules without wax coat.

This indicates that the conventional methods for preparation of agrochemical granules using inert carriers such as sand are not suitable for azadirachtins as they quickly release azadirachtins in contact with water, which is undesirable. Even coating with wax at levels of 0.25-0.5 wt % resulted only in a slight improvement in encapsulation. Use of higher quantities of wax than 0.5 wt % to improve the encapsulation can result in agglomeration of granule particles. In addition to low encapsulation, the granules have shown shorter shelf life for azadirachtin, which indicated that it may be due to the presence of several ingredients used in the preparation of granules which have caused degradation due to their adverse effects on azadirachtin. Hence, use of several ingredients, which is seen in general in conventional granule preparation may have limitations when applied for azadirachtin granules preparation.

B. Studies on Impregnation of Neem Seed Extract Containing Azadirachtin in Granular Form.

With an objective to identify a process and composition with a minimum number of additives, but improved encapsulation and stability for azadirachtin, granular compositions 3 to 30 were prepared. Carriers such as sand and bentonite, binders or additives such as poly vinyl alcohol (PVA), rosin, beeswax, paraffin wax, pressmud wax, turpentine oil, neem oil, pine oil and polyethylene glycol (PEG) were used. The compositions of these formulations (100 g each) are given in Table 1 and the process for their preparation was as follows.

### Example II

Preparation of Formulations: Formulations are prepared as per the procedures mentioned in example I-A

### Example III

Formulations 3-24: These formulations were prepared using sand without pre-treatment.

Step 1: Sand preparation: The sieved river sand, particle size of 500 to 1000 mesh size (microns), was washed with water and dried under a hot current of air (50-70° C.) until the bound moisture content reached below 2 wt %. Commercial Bentonite was used directly without washing.

Step 2: Impregnation of neem seed extract containing azadirachtins: About 98.7 g of the sieved particles of sand or bentonite (500 to 1400 mesh size (microns)) were added to a conical flask. About 0.3 g of neem seed extract (eq to 0.1% of Azadirachtin) solution dissolved in 5 ml of ethyl acetate was added slowly to the flask. The contents were mixed thoroughly and dried under the current of air.

Step 3: Coating of different binders over neem extract impregnated granules The neem seed extract impregnated granules in a conical flask and solutions of various binders alone or in combination were dissolved in 5 ml of (Beeswax—0.25-1 g; Rosin—0.1-0.5 g, Turpentine oil—1 g; Neem oil—1 g) and added drop wise. The contents were mixed thoroughly and dried under the current of air to obtain free flowing granules.

### Example IV

Formulations: 25-30

These formulations were with sand and bentonite granules, which were pre-coated with beeswax/paraffin wax before coating neem seed extract and other binders with the purpose of improving encapsulation. The process involved the following steps:

Step 1: Preparation of river sand: The river sand was sieved to obtain sand particles of size of 500 to 1000 mesh size (microns), washed with water and dried under a hot current of air until the bound moisture content reached below 2 wt %. Commercial bentonite was used directly without washing.

Step 2: Pre-coating of wax on carrier: A solution of binders (beeswax, 0.25 g; paraffin wax, 0.25 g) dissolved in about 5 ml of n-hexane was added drop wise to about 98 g of sand or bentonite obtained in Step 1. The contents were thoroughly mixed for uniform distribution of the wax substance over the surface of sand, and dried in a current of air to obtain free flowing particles.

Step 3: Impregnation of neem seed extract containing azadirachtin: 0.3 g of neem seed extract (eq to 0.1% of azadirachtin) was dissolved in about 5 ml of methanol and the solution was added drop wise to the wax coated particles obtained in Step 2. The contents were mixed thoroughly and dried under the current of air or in a hot air oven at 50° C. for 2 hours.

Step 4: Post coating of wax on neem seed extract impregnated granules: The neem seed extract impregnated granules obtained in Step 3 was treated slowly with respective solutions of wax (beeswax, 0.75 g; paraffin wax, 0.75 g; pressmud wax, 0.75 g) prepared as in step 2. The contents were mixed thoroughly and dried under the current of air or in a hot air oven at a temperature below 50° C. for 2 hrs to obtain free flowing granules.

The use of water from step 2 onwards was avoided as it is known to degrade azadirachtin and also leads to difficulty in drying at preferably low temperatures. Hence, the usual binders, such as guar gum, gum arabic, and the like, which are hydrophilic in nature, could not be used due to their insolubility in solvents.

The extent of encapsulation was tested using a ‘water run-off’ test as described in Example 1A and the results are given in Table 1.

TABLE 1

| | | Wt % Aza |
|---|---|---|
| Formulation | | release on |
| No | Composition (by wt %) | Water Run Test |
| 1 | Sand - 94.3%, Neem seed extract - 0.4%, White clay - 4%, | 90% |
| | Sugar - 1%, PVA - 0.2%, Noigen - 0.23%, Crystal violet - 0.03% | |
| 2 | Sand - 94.8%, Neem seed extract - 0.4%, White clay - 4%, | 72% |
| | Sugar - 1%, PVA - 0.2%, Noigen - 0.23%, Crystal violet - 0.03%, | |
| | beeswax - 0.5% | |
| 3 | Sand - 99.72%, Neem Seed Extract 0.28%, | 67.62% |
| 4 | Sand - 98.72%, Neem Seed Extract 0.28%, Beeswax - 1.0% | 16.6 |
| 5 | Sand - 98.71%, Neem Seed Extract 0.29%, Beeswax - 0.5%, | 1.47% |
| | Rosin - 0.5% | |
| 6 | Sand - 98.97%, Neem Seed Extract 0.28%, Beeswax - 0.5%, | 3.0% |
| | Rosin - 0.25% | |
| 7 | Sand - 98.72%, Neem Seed Extract 0.28%, Beeswax - 0.5%, | 48.77% |
| | PVA - 0.50% | |
| 8 | Sand - 98.71%, Neem Seed Extract 0.29%, Beeswax - 0.25%, | 3.23% |
| | Cyclohexanone - 0.50%, Rosin - 0.25% | |
| 9 | Sand - 97.95%, Neem Seed Extract 0.30%, Beeswax - 0.5%, | 3.12% |
| | Cyclohexanone - 1%, Rosin - 0.25% | |
| 10 | Sand - 98.96%, Neem Seed Extract 0.29%, Beeswax - 0.25%, | 32.03% |
| | Cyclohexanone - 0.5% | |
| 11 | Sand - 98.86%, Neem Seed Extract 0.29%, Beeswax - 0.25%, | 10.84% |
| | Cyclohexanone - 0.5%, Rosin - 0.10% | |
| 12 | Sand - 98.31%, Neem Seed Extract 0.29%, Rosin - 0.40%, | 32.64% |
| | Turpentine Oil - 1.0%. | |
| 13 | Sand - 97.71%, Neem Seed Extract 0.29%, Rosin - 1.0%, | 10.63% |
| | Turpentine Oil - 1.0%. | |
| 14 | Sand - 96.72%, Neem Seed Extract 0.28%, Rosin - 1.5%, | 6.69% |
| | Turpentine Oil - 1.5%. | |
| 15 | Sand - 93.72%, Neem Seed Extract 0.28%, Rosin - 1.0%, Pine | 10.4% |
| | Oil - 5%. | |
| 16 | Sand - 98.31%, Neem Seed Extract 0.29%, Rosin - 0.40%, | 61.48% |
| | Neem Oil - 1.0%. | |
| 17 | Sand - 97.72%, Neem Seed Extract 0.28%, Beeswax - 1.0%, | 19.64% |
| | Neem Oil - 1.0%. | |
| 18 | Bentonite Granules - 98.71%, Neem Seed Extract 0.29%, | 8.2% |
| | Beeswax - 1.0% | |
| 19 | Bentonite Granules - 97.71%, Neem Seed Extract 0.29% Rosin - | 4.8% |
| | 1.0%, Turpentine Oil - 1.0% | |
| 20 | Bentonite Granules - 98.71%, Neem Seed Extract 0.29%, | 10.07% |
| | Beeswax - 0.5%, Rosin - 0.5% | |
| 21 | Sand - 98.62%, Neem Seed Extract 0.28%, Beeswax - 1.0%, | 11.84% |
| | Rosin - 0.10% | |
| 22 | Sand - 98.52%, Neem Seed Extract 0.28%, Beeswax - 1.0%, | 5.7% |
| | Rosin - 0.20% | |
| 23 | Sand - 98.72%, Neem Seed Extract 0.28%, PEG - 1.0% | 70.5% |
| 24 | Sand - 98.72%, Neem Seed Extract 0.28%, PEG - 0.50%, | 62.8% |
| | Beeswax - 0.5% | |
| 25 | Wax coated Sand - 98.98%, Neem Seed Extract 0.27%, | 8.9 |
| | Beeswax - 0.75%. (0.25% pre-coat, 0.50% post-coat) | |
| 26 | Wax coated sand - 98.92%, Neem Seed Extract 0.28%, | 6.0 |
| | Paraffin Wax - 0.75%(0.25% pre-coat, 0.50% post-coat), | |
| | Turmeric Extract - 0.05%. | |
| 27 | Wax coated sand - 98.98%, Neem Seed Extract 0.27%, | 14.0 |
| | Pressmud Wax - 0.75%(0.25% pre-coat, 0.50% post-coat) | |
| 28 | Wax coated bentonite - 98.97%, Neem Seed Extract 0.28%, | 16.0 |
| | Paraffin Wax - 0.75% (0.25% pre-coat, 0.50% post-coat) | |
| 29 | Wax coated bentonite - 98.72%, Neem Seed Extract 0.28%, | 14.9 |
| | Paraffin Wax - 1.00%(0.5% pre-coat, 0.5% post-coat), | |
| 30 | Wax coated sand, 95.4%, Neem seed extract, 3.0%, Paraffin | 3.4 |
| | wax, 1.5% (0.5% pre-coat, 1% post-coat), crystal violet 0.02% | |

(Note: Aza = Azadirachtins)

The results indicated that the granules made by coating the azadirachtin containing neem extract directly on to sand (Formulation 3) without any binder gave faster release of azadirachtin. Binders, such as polyethylene glycol, polyvinyl alcohol did not provide a controlled release of azadirachtin where as beeswax and rosin have imparted gradual release of azadirachtin. Further, granules which are made with sand or bentonite carriers pre-coated with wax have provided comparatively higher encapsulation.

### Example V

Stability of Granules with Different Carriers and Additives Possessing Higher Encapsulation of Azadirachtin Containing Neem Extract:

The formulations which have shown improved encapsulation by releasing about 15 wt % azadirachtin in the ‘water run-off’ test of Example 1 (Table 2) were studied for their stability under accelerated conditions at 54±2° C. About 80 g. of granules of each formulation were placed into air tight glass vials and incubated in a hot air oven for 28 days. Samples were taken out from the oven at designated intervals and analysed for azadirachtin by HPLC as per the method prescribed in Bureau of Indian Standard specification IS: 14299-1995. The degradation of azadirachtin in these formulations is given in Table 2.

TABLE 2

| | | Initial Aza | | % Rentention of Azadirachtin (by weight) | | | | | | | |
|---|---|---|---|---|---|---|---|---|---|---|---|
| | Composition | Content (wt %) | | 1 Day | | 7 Days | | 14 Days | | 28 Days | |
| Formulation | (by wt %) | Aza A | Aza B | Aza A | Aza B | Aza A | Aza B | Aza A | Aza B | Aza A | Aza B |
| 4 | Sand - 98.72%, | 0.066 | 0.017 | 93.37 | 97.68 | 88.39 | 86.48 | 88.95 | 84.40 | 82.93 | 89.58 |
| | Neem Seed Extract | | | | | | | | | | |
| | 0.28%, Beeswax - | | | | | | | | | | |
| | 1.0% | | | | | | | | | | |
| 5 | Sand - 98.71%, | 0.093 | 0.023 | 88.46 | 87.7 | 82.63 | 84.77 | 64.81 | 79.46 | NA | NA |
| | Neem Seed Extract | | | | | | | | | | |
| | 0.29%, Beeswax - | | | | | | | | | | |
| | 0.5%, Rosin - 0.5% | | | | | | | | | | |
| 6 | Sand - 98.97%, | 0.080 | 0.026 | 78.43 | 77.51 | 65.46 | 65.84 | 52.07 | 52.52 | 42.45 | 44.69 |
| | Neem Seed Extract | | | | | | | | | | |
| | 0.28%, Beeswax - | | | | | | | | | | |
| | 0.5%, Rosin -0.25% | | | | | | | | | | |
| 8 | Sand - 98.71%, | 0.093 | 0.022 | 80.95 | 97.84 | 63.36 | 72.15 | 49.10 | 57.81 | NA | NA |
| | Neem Seed Extract | | | | | | | | | | |
| | 0.29%, Beeswax - | | | | | | | | | | |
| | 0.25%, | | | | | | | | | | |
| | Cyclohexanone - | | | | | | | | | | |
| | 0.50%, Rosin - | | | | | | | | | | |
| | 0.25% | | | | | | | | | | |
| 9 | Sand - 97.95%, Neem | 0.095 | 0.023 | 79.86 | 90.82 | 65.16 | 66.60 | 52.71 | 52.18 | NA | NA |
| | Seed Extract 0.30%, | | | | | | | | | | |
| | Beeswax - 0.5%, | | | | | | | | | | |
| | Cyclohexanone - 1%, | | | | | | | | | | |
| | Rosin - 0.25% | | | | | | | | | | |
| 11 | Sand - 98.86%, Neem | 0.089 | 0.029 | 78.3 | 71.77 | 81.20 | 65.92 | 63.05 | 30.01 | 48.33 | 47.17 |
| | Seed Extract 0.29%, | | | | | | | | | | |
| | Beeswax - 0.25%, | | | | | | | | | | |
| | Cyclohexanone - | | | | | | | | | | |
| | 0.5%, Rosin - 0.10% | | | | | | | | | | |
| 13 | Sand - 97.71%, Neem | 0.092 | 0.026 | 74.16 | 88.4 | 68.69 | 50.34 | NA | NA | NA | NA |
| | Seed Extract 0.29%, | | | | | | | | | | |
| | Rosin - 1.0%, | | | | | | | | | | |
| | Turpentine Oil - | | | | | | | | | | |
| | 1.0%. | | | | | | | | | | |
| 17 | Sand - 97.72%, Neem | 0.083 | 0.028 | 91.16 | 83.45 | 73.82 | 67.02 | 33.48 | 31.68 | 8.86 | 11.56 |
| | Seed Extract 0.28%, | | | | | | | | | | |
| | Beeswax - 1.0%, | | | | | | | | | | |
| | Neem Oil - 1.0%. | | | | | | | | | | |
| 20 | Bentonite Granules- | 0.092 | 0.023 | 18.66 | 27.92 | NA | NA | NA | NA | NA | NA |
| | 98.71%, Neem Seed | | | | | | | | | | |
| | Extract 0.29%, | | | | | | | | | | |
| | Beeswax - 0.5%, | | | | | | | | | | |
| | Rosin - 0.5% | | | | | | | | | | |
| 21 | Sand - 98.62%, | 0.076 | 0.023 | 91.78 | 88.60 | 78.79 | 78.87 | 73.63 | 72.47 | 60.06 | 67.83 |
| | Neem Seed Extract | | | | | | | | | | |
| | 0.28%, Beeswax - | | | | | | | | | | |
| | 1.0%, Rosin - 0.10% | | | | | | | | | | |
| 22 | Sand - 98.52%, Neem | 0.079 | 0.024 | 81.71 | 82.10 | 65.60 | 70.13 | 56.19 | 56.37 | 44.70 | 45.94 |
| | Seed Extract 0.28%, | | | | | | | | | | |
| | Beeswax - 1.0%, | | | | | | | | | | |
| | Rosin - 0.20% | | | | | | | | | | |
| 25 | Wax coated Sand - | 0.072 | 0.022 | 98.17 | 96.37 | 96.28 | 96.71 | 91.50 | 96.19 | 84.11 | 82.90 |
| | 98.98%, Neem Seed | | | | | | | | | | |
| | Extract 0.27%, | | | | | | | | | | |
| | Beeswax - 0.75%. | | | | | | | | | | |
| | (0.25% pre-coat, 0.5% | | | | | | | | | | |
| | post-coat) | | | | | | | | | | |
| 26 | Wax coated sand - | 0.076 | 0.022 | 91.21 | 100.0 | 89.87 | 98.97 | NA | NA | 79.82 | 86.17 |
| | 98.92%, Neem Seed | | | | | | | | | | |
| | Extract 0.28%, | | | | | | | | | | |
| | Paraffin Wax - | | | | | | | | | | |
| | 0.75%, (0.25% pre- | | | | | | | | | | |
| | coat, 0.5% post-coat) | | | | | | | | | | |
| | Turmeric Extract - | | | | | | | | | | |
| | 0.05%. | | | | | | | | | | |
| 27 | Wax coated sand - | 0.061 | 0.017 | 87.07 | 96.18 | 86.14 | 89.33 | NA | NA | 62.84 | 78.99 |
| | 98.98%, Neem Seed | | | | | | | | | | |
| | Extract 0.27%, | | | | | | | | | | |
| | Pressmud Wax - | | | | | | | | | | |
| | 0.75% (0.25% pre- | | | | | | | | | | |
| | coat, 0.5% post-coat) | | | | | | | | | | |
| 28 | Wax coated | 0.070 | 0.020 | 15.7 | 39.3 | NA | NA | NA | NA | NA | NA |
| | bentonite - | | | | | | | | | | |
| | 98.97%, Neem | | | | | | | | | | |
| | Seed Extract | | | | | | | | | | |
| | 0.28%, Paraffin | | | | | | | | | | |
| | Wax - 0.75% | | | | | | | | | | |
| | (0.25% pre-coat, | | | | | | | | | | |
| | 0.5% post-coat) | | | | | | | | | | |
| 29 | Wax coated | 0.07 | 0.02 | 11.3 | 37.6 | NA | NA | NA | NA | NA | NA |
| | bentonite - | | | | | | | | | | |
| | 98.72%, Neem | | | | | | | | | | |
| | Seed Extract | | | | | | | | | | |
| | 0.28%, Paraffin | | | | | | | | | | |
| | Wax 1.00% | | | | | | | | | | |
| | (0.5% pre-coat, | | | | | | | | | | |
| | post-coat - 0.5%) | | | | | | | | | | |
| 30 | Wax coated | 0.80 | 0.19 | N.A. | N.A. | 93.91 | 95.822 | 88.44 | 91.63 | 82.59 | 86.92 |
| | sand, 95.4%, | | | | | | | | | | |
| | Neem seed | | | | | | | | | | |
| | extract, 3.0%, | | | | | | | | | | |
| | Paraffin wax, | | | | | | | | | | |
| | 1.5% (0.5% pre- | | | | | | | | | | |
| | coat, 1% post- | | | | | | | | | | |
| | coat), crystal | | | | | | | | | | |
| | violet 0.02% | | | | | | | | | | |

NA = Not Analysed,

The results indicated that formulations which are made of sand as a carrier and beeswax as a deactivator/binder provide higher stability to azadirachtin to those using a bentonite carrier and rosin, turpentine oil, neem oil as binder/additives even though the latter have shown higher encapsulation of azadirachtins (Example 1). But in view of the stability of azadirachtin, these additives were found less suitable to be used in formulations. The formulations which are made out of sand carrier and beeswax/paraffin wax as deactivator/binder have shown both stability and higher encapsulation. The stability and encapsulation are further improved if azadirachtins containing extracts are coated on wax-coated sand granules, which is one of the inventive concepts of the present application.

### Example VI

A. Efficacy of Azadirachtin Containing Neem Seed Extract Granular Formulation Against, Nilaparvata lugens (Brown Plant Hopper, BPH) Insect on Rice

The azadirachtin containing granular formulation, 25, prepared according to the present invention was tested against BPH insects. The insects used for the bioassay were from cultures maintained in the laboratory. Rice seedlings were raised in trays and maintained in the laboratory and 30 day old seedlings were used in the study. The test solutions containing 25 ppm, 50 ppm, and 100 ppm of azadirachtin were prepared by adding a quantity of granules (5.5, 11 and 22 g respectively) in 200 ml of water placed in pet jars (Jar 1, Jar 2, and Jar 3, respectively). A bunch of rice seedlings were immersed in the treated solutions. For bio-efficacy evaluation, nine seedlings from each of the pet jars (1-3) were taken out after 24 hrs of treatment and planted in clay pots (3×3 plants) in three replications for each concentration. Plants, which were not treated with granules, were used as a control. The seedlings were then enclosed in mylar cages (10 cm dia & 30 cm high). Ten newly emerged BPH nymphs were transferred in to each of the cages and the top of each mylar cage was covered with a wet muslin cloth. The pots were watered continuously through out the study. The mortality of BPH insects is observed on 1^{st}, 3^{rd}, 5^{th}, 7^{th}, 9^{th}, 11^{th}, and 14^{th} days after treatment and the corrected mortality was determined using Abbot's formula.

TABLE 3
Mortality of BPH fed on rice seedlings treated with the granular
formulation of the present invention.

| Treatments | Mortality* (%) | | | | | | |
|---|---|---|---|---|---|---|---|
| (Azadirachtin) | 1 DAY | 3 DAY | 5 DAY | 7 DAY | 9 DAY | 11 DAY | 14 DAY |
| 25 ppm | 0.00 | 16.66 | 46.66 | 70.00 | 83.33 | 86.66 | 93.33 |
| | (0.00) | (16.67) | (46.67) | (70.00) | (82.76) | (86.21) | (93.10) |
| 50 ppm | 0.00 | 13.33 | 50.00 | 73.33 | 83.33 | 90.00 | 100.00 |
| | (0.00) | (13.33) | (50.00) | (73.33) | (82.76) | (89.66) | (100.00) |
| 100 ppm | 0.00 | 10.00 | 43.33 | 70.00 | 86.66 | 96.66 | 100.00 |
| | (0.00) | (10.00) | (43.33) | (70.00) | (86.21) | (96.55) | (100.00) |
| Untreated | 0.00 | 0.00 | 0.00 | 0.00 | 3.33 | 3.33 | 3.33 |
| control | | | | | | | |

*Corrected mortality is in parenthesis

The bio-efficacy results indicate 93-100% mortality of BPS which is attributed to the granules.
B. Systemic Absorption of Azadirachtin by Rice Plants Treated with Azadirachtin Granules:

Systemic absorption of azadirachtin was monitored in rice seedlings immersed in three jars containing granule treated water. The seedlings were removed from each of the jars on the 1^{st} and 3^{rd} days, and extracted and analyzed for azadirachtin content by HPLC (Table 4).

TABLE 4

| | Azadirachtin A + B(in ppm) in Rice seedlings | | |
|---|---|---|---|
| Day of | dipped in different doses of granules | | |
| Analysis | 25 ppm | 50 ppm | 100 ppm |
| 0-day | 7.3 | 17.3 | 34.1 |
| 1-Day, | 5.4 | 6.6 | 9.4 |
| after 24 hrs | 4.0 | 3.2 | 7.0 |
| 3rd-day, | | | |
| after 72 hrs | | | |

The HPLC results indicate absorption of azadirachtin by rice seedlings in proportion to the dosage of the granules, namely 25, 50 and 100 ppm respectively.

### Example VII

Preparation of azadirachtin containing neem seed extract granules in ton quantities as per the present invention involved the following steps.

Step-1: Sand preparation: Sand having a particle size of 1190μ/550μ (500 to 1000 mesh size (microns)), was obtained by sieving 4450 kg of raw river sand in a sieve shaker. This sand was taken in a Mild steel tank provided with an agitator and washed with hot water at about 70° C. to remove the adhering impurities. The water was discarded and the cleaned sand thus obtained was transferred to a Mild steel dryer. Drying took place at 60° C. under normal conditions over a period of 4 hrs. The clean sand of 1000 kg with a moisture content in the sand of <0.05 wt % was obtained. 989.3 kg of the dried sand was charged in to a coating pan.

Step-2: Pre-wax coating: n-Hexane, 58.3 kg (eq. to 5.83% of the batch size) was added to a stainless steel 304 mixing vessel. Gradually, with agitation, 2.5 kg of Paraffin wax (eq. to 0.25%) was added and the addition was done at 60 Deg C. The Paraffin wax was dissolved in the n-Hexane completely, typically within one hour. The paraffin wax solution was sprayed slowly at the rate of 14.5 kg/hr on to the sand, rotating in the pan at a speed of 10 rpm. The drying was done simultaneously by means of hot air blower mechanism by maintaining the temperature below 50° C., preferably at about 47° C. to ensure uniform coating of paraffin wax on the sand while the coating process was carried out for four hours.

Step-3: Impregnation of neem seed extract containing azadirachtin: Ethyl acetate, 58.3 kg (eq. to 5.83 wt % of the batch size) was taken into a stainless steel 304 mixing vessel. Gradually, with agitation, about 3.245 kg of extract equivalent to 1.0 kg of 100% Azadirachtin (eq. to 0.12 wt % of the batch size) was added. Agitation was continued until the complete dissolution of the extract in methanol was obtained, typically within one hour. The neem seed extract solution thus obtained was sprayed slowly at the rate of 14.5 kg/hr on to the wax coated sand granules, in the pan rotating at a speed of 10 rpm. The drying was done simultaneously by means of a hot air blower rotating mechanism by maintaining the temperature below 50° C., preferably at about 42° C. to ensure uniform impregnation of the neem seed extract on the wax coated sand granules. This process was carried out for four hours.

Step-4, Coating with coloring agent: Ethyl alcohol, 11.6 kg (eq. to 1.16 wt % of the batch size) was added to a stainless steel 304 mixing vessel. Gradually, with agitation, 0.2 kg of Methyl violet (eq. to 0.02 wt % of the batch size) was added. Agitation was continued until it was completely dissolved, typically for one hour. This solution was sprayed gently at the rate of 3 kg/hr on to the Azadirachtin containing neem seed extract impregnated sand granules, in the pan rotating at a speed of 10 rpm. The drying was done simultaneously by means of a hot air blower mechanism by maintaining the temperature below 50° C. To ensure uniform coating of the coloring agent, the process was carried out for four hours.

Step-5, Post-wax coating: n-Hexane, 58.3 kg (eq. to 5.83 wt % of the batch size) was added to a stainless steel 304 mixing vessel. Gradually, with agitation, 5 kg of Paraffin wax (eq. to 0.5 wt % of the batch size) was added and the addition was done at 60 Deg C. The paraffin wax was dissolved in the n-Hexane completely, typically within one hour. The solution was sprayed gently at the rate of 14.5 kg/hr on to the color coated sand granules, in the pan rotating at a speed of 10 rpm. The drying was done simultaneously by means of hot air blower mechanism by maintaining the temperature below 50° C., preferably 47° C. To ensure uniform coating of the paraffin wax over color coated sand granules. The process was carried out for four hours.

Step 6: Packing: The dried formulated product was packaged in thick double polyethylene bags of thickness not less than 0.062 mm, with each sample inside high density polyethylene drums, fiber board cartons, or mild steel drums. Package sizes include 5, 10 and 20 kilograms.

Main Advantages:

1) Enhanced storage stable granular pest control formulation containing azadirachtin.
2) Gradual release of active constituents' azadirachtin from the granular formulation enabling prolonged efficacy.
3) Cost effective formulation and a simple process for the preparation of the same.
4) Eco-friendly granular formulation ideal for organic agriculture.
5) Easy availability of solid carriers and other ingredients used in the granular formulation.

I claim:

1. A granular formulation comprising by wt./wt (%) of overall formulation:
a) a neem seed extract containing azadirachtin, wherein said neem seed extract is present in an amount from 0.03 to 50.00 wt %,
b) at least one solid carrier in an amount of from 48.50 to 99.30 wt %,
c) at least one lipophilic substance in an amount of from 0.50 to 1.50 wt %, and
d) optionally at least one colorant in an amount of from 0.01 to 0.04 wt %.

2. The granular formulation of claim 1, wherein said at least one lipophilic substance coats said solid carrier to form a coated carrier and wherein said coated carrier is treated with said neem seed extract.

3. The granular formulation of claim 1, wherein said neem seed extract comprises azadirachtin, which is present in the granular formulation in an amount of from about 0.03 wt % to about 5.0 wt %, based on the weight of the granular formulation.

4. The granular formulation of claim 1, wherein said formulation is storage stable, wherein at least 85% by weight of the azadirachtin originally present remains after 28 days of storage at 54° C. in a sealed container.

5. The granular formulation of claim 1, wherein said granular formulation provides the gradual release of azadirachtin such that the azadirachtin is released less than 15% by weight of its original content during a 10-minute period when the granular formulation is brought into contact with water.

6. The granular formulation of claim 1, wherein said solid carrier is silica.

7. The granular formulation of claim 1, wherein said solid carrier is sand.

8. The granular formulation of claim 1, wherein said lipophilic substance comprises wax.

9. The granular formulation of claim 1, wherein said solid carrier is silica and said lipophilic substance is wax.

10. The granular formulation of claim 1, wherein said neem seed extract is present in an amount of from 0.075% to 12.5% by weight, said silica is present in an amount of from 86.7% to 99.20% by weight, said wax is present in an amount of from 0.60% to 0.75% by weight, and said colorant, which is optional, is present in an amount of from 0.00% to 0.03% by weight.

11. The granular formulation of claim 10, wherein said wax is natural wax.

12. The granular formulation of claim 6, wherein said silica is sand obtained from rocks, minerals, shell, corals, or is precipitated silica or synthetic silica.

13. The granular formulation of claim 1, wherein said lipophilic substance is beeswax, vegetable wax, soy wax, sugar cane wax, gel wax, palm wax, paraffin wax, haze wax, mineral wax, or combinations thereof.

14. The granular formulation of claim 1, wherein the content of azadirachtin in the neem seed extract ranges from 0.03 to 5.0 % (w/w).

15. The granular formulation of claim 1, wherein the content of azadirachtin in the neem seed extract is up 1.0 % (w/w).

16. The granular formulation of claim 1, wherein the solid carrier has a particle size from 500 to 1400 mesh size (microns).

17. The granular formulation of claim 1, wherein said solid carrier has a moisture content below 2.0 wt %.

18. The granular formulation of claim 1, wherein said colorant is present and is crystal violet, methyl violet, natural bixin, turmeric, or mixtures thereof.

19. A process for preparing the granular formulation of claim 1, comprising:
a) washing the solid carrier with water, drying said solid carrier, and sieving to obtain a dried carrier,
b) coating the dried carrier of step (a) with at least one lipophilic substance dissolved in an organic solvent to obtain a coated carrier,
c) impregnating the coated carrier of step (b) with neem seed extract dissolved in a solvent, and drying to obtain an impregnated material,
d) optionally coating with colorant dissolved in a solvent by spraying said impregnated material, and drying, and
e) coating the impregnated material of step (c) or (d) with a lipophilic substance, which is the same or different from step (b), and drying.

20. The process of claim 19, wherein said solid carrier is silica.

21. The process of claim 19, wherein said solid carrier is sand.

22. The process of claim 19, wherein said drying in step (a) is at a temperature of from about 50° C. to about 70° C., said drying in step (c) is in a stream of hot air at a temperature of from about 40° C. to about 50° C., said drying in step (e) is at a temperature of from about 40° C. to about 50° C., and said drying in optional step (d) is at a temperature of from about 40° C. to about 50° C.

23. The process of claim 19, wherein said lipophilic substance in step (b) or step (e) or both is a wax.

24. The process of claim 23, wherein said wax is a natural wax.

25. The process of claim 19, wherein the said solid carrier is sand obtained from rocks, minerals, shell, or corals, or is precipitated silica or synthetic silica.

26. The process of claim 19, wherein said solid carrier has a particle size of from 500 to 1400 mesh size (microns).

27. The process of claim 19, wherein said solid carrier has a moisture content below 2.0 wt %.

28. The process of claim 19, wherein, in step (b), said organic solvent is an ether, ketone, aldehyde, or an ester.

29. The process of claim 19, wherein in steps (b) and (e), said lipophilic substance is beeswax, vegetable wax, soy wax, sugar cane wax, gel wax, palm wax, paraffin wax, haze wax or mineral wax.

30. The process of claim 19, wherein in step (c) the neem seed extract is dissolved in a solvent that is an ether, ketone, alcohol, aldehyde, or ester.

31. The process of claim 19, wherein in step (c) said neem seed extract comprises azadirachtin in an amount of from 0.03 % to 5.0 % w/w.

32. The process of claim 31, wherein the neem seed extract comprises 1% w/w azadirachtin.

33. The process of claim 19, wherein in step (d), said colorant is present and is crystal violet, methyl violet, bixin, turmeric, or mixtures thereof.
